(19) United States
(12) Patent Application Publication
(10) Pub. No.: US 2013/0013592 A1
(43) Pub. Date: Jan. 10, 2013

(54) System for Engaging Experts and Organizing Recorded Media

(76) Inventors: Abhijeet Narvekar, Houston, TX (US); Dhimant Desai, Coppell, TX (US)

(21) Appl. No.: 13/544,986

(22) Filed: Jul. 9, 2012

Related U.S. Application Data
(60) Provisional application No. 61/505,534, filed on Jul. 7, 2011.

(51) Int. Cl. G06F 17/30

(52) U.S. Cl. 707/723; 707/758; 707/E17.014

(57) ABSTRACT

A system for selecting an expert and receiving expert evaluation data comprising: a computer having access to a database comprising subject matter expert data; where said computer is programmed to perform computer-implemented operations comprising:
receiving user input comprising solution requirement data;
accessing said database comprising subject matter expert data and comparing said solution requirement data to said subject matter expert data;
selecting at least one subject matter expert;
outputting solution requirement data to said subject matter expert; and
receiving solution option data based on said subject matter expert's evaluation.

This application claims the benefit of provisional application 61/505,534 filed on Jul. 7, 2011, which is hereby incorporated in full.

### BACKGROUND

### Interview Process:

The process of interviewing applicants for job openings, or other similar competitive positions (school admissions, etc.) is commonly used to separate the best fitting candidates for the given position from those who would not be an ideal selection. Due to this common practice of screening applicants, the interviewing of applicants for a particular position is well known in the art. However the long held process of the interview has advanced little despite rapidly progressing technology. Even though companies and schools have embraced the use of phone interviews in order to minimize travel expenses the fundamental process of the interview is changed very little. While these interviews through interpersonal interaction allow for a dynamic process with follow up questions tailored to the individual applicants or their responses, they do not allow for a side by side comparison of multiple applicants. Furthermore, since these styles of screening rely on individual interviewers, interviewers who often screen a multitude of candidates for the same (or similar) position(s) over a period of time, the problems of fading memory, or blurring together of applicants are presented.

To mitigate the limitations of human memory and allow for side by side comparison many institutions ask their applicants to respond to questionnaires through either writing or multiple choice. With the use of questionnaires the screening institution loses the ability to ask follow up questions, or otherwise tailor the screening mechanism to the individual applicant.

### Keyword Searching:

In order to access data specific to a certain field, online databases often utilize a key word search function. This sorting methodology limits the searcher's access only to data that contains the specific keyword entered. By using a key word filter, databases are able to narrow the scope of the material returned to the searcher, but it does so based only on the use of the particular word (or set of words). This action can easily fail to return material pertinent to the searcher's query simply because it does not contain the specific key word. Data management systems based on key word usage is a means by which to sort information, including media, but such organization is superficially based on the language used and not on the qualitative aspects of the data.

Furthermore, the internet has created and promulgated the use of links between different sets of data based on the similar key words. Wikipedia.org uses this key word linking internally between its own pages so that the searcher may simply click on a hyperlinked word to be directed to the Wikipedia page based on that word.

### Database Searching:

Databases, specifically those focusing on the storage and organization of media, have grown not only in number but also in size due to the expansive reach and depth of the internet. With the massive increase in media volume and diversity spurred on by the internet, there comes the difficulty of organizing said media in a user friendly way. Most media databases use a keyword system to filter out all media whose title or description does not include said keyword. This keyword system is limited in its organizational ability due to its focus on only the words being used to describe the media. It fails to address any of the qualitative aspects of the media being sorted. Because of the lack of qualitative reference incorporated into the keyword search function, a video clip in low resolution is just as likely to be provided to the user up as a high definition video clip of the same thing if they have the same keyword in their title or description.

The issue of failure to address the quality of media that presents itself in keyword based database searches has been addressed by many media databases. Collaborative filtering, a process by which users rate media so as to provide a qualitative aspect to the media's organization, has been utilized by many such media databases. The effectiveness of collaborative filtering can be increased even more by linking users who have similar dispositions toward the media (as indicated by their similar ranking of media). However, this collaborative filtering takes a significant amount of time and effort by the individual users to develop a useful system that indicates the media's true quality based on an average ranking of a large cross-section of users. This provides further organizational complications in that newly accessible media would remain low on the quality list because, having not yet been ranked by users, other users would view the new media as of low quality. This tendency causes a cycle in which established high ranked media will be proliferated, while new media will remain uncirculated due to its introduction at an unranked level of quality.

### Expert Systems:

The expert system program is primed using a knowledge representation system to create a knowledge base for the expert system based on knowledge provided by SMEs. Once the expert system has been primed with the knowledge from the SMEs it can then apply that knowledge base to future inputted data. After being primed by the SMEs the expert system can apply the SME knowledge analysis to any inputted data without further need of the actual SMEs. By removing the continuing evaluation of data by the SMEs after they have primed the expert system's data base and replacing it with analysis by the computerized expert system companies are able to maintain high level evaluation of data in databases at faster speeds and for less cost.

### DESCRIPTION

According to an embodiment of the present invention, subject matter experts (SMEs) from a field relating to an open position could interact with a system to be part of a candidate screening process. “Subject matter expert” is defined as a person with direct knowledge of what is done in the job, what knowledge, skills, abilities and other characteristics are required, and the general background of persons who are able to do the job successfully. These may include those currently doing the job, recent incumbents, those who supervise others doing the job, and other acknowledged job experts. These SMEs could use their extensive knowledge of the specific field that the applicant is applying for in order to evaluate the applicants' respective aptitude for the position. Through ranking systems established by inputting relevant data and algorithms into the system a hierarchy of applicants can be established, allowing the system to differentiate the best applicants from inferior applicants.

An embodiment of the present invention used to pre-screen job candidates for a potential employer, could comprise a machine running database management software that receives input from subject matter experts and/or potential employers, records candidate interviews via video/audio or other media, receives a subject matter expert's evaluation of the candidate's recorded media content, calculates a candidate rating, and outputs a candidate rating.

An embodiment of the present invention that is oriented toward job applicant selection could comprise a software solution to screen and evaluate options for a particular job requirement, using inputs from candidates and unbiased subject matter experts. These inputs include but are not limited to: resume, recommendation(s), expert interview recorded in video, audio, text messaging, coding, etc. format, or text transcriptions of above mentioned interviews, expert recommendations etc. For example, to evaluate applicants for a computer programming position, an applicant and a subject matter expert could interact via a computer system running software according to the present invention. This interaction could comprise the expert presenting a problem to be solved by writing a computer program. After the candidate completes the coding task the expert can review and evaluate the program that the applicant writes to solve the problem via the computer system of the present invention. The expert can follow up by asking the applicant questions about the computer program. The expert can then evaluate the applicant's answers and the computer system receives the expert's input. Questions, answers, and the candidate's program are recorded and indexed by the computer system to facilitate reference to relevant information. A system according to the present invention could generate a score for each candidate with higher scores signifying a better fit for a given position. A single candidate response could generate different expert scores for a plurality of open positions, depending on how that response suits the requirements of each open position. A candidate may interact with a single expert or a plurality of experts. Candidate/expert interactions may be real-time or iterative. Candidate/expert interactions can be facilitated, recorded, and indexed by a system running software according to the present invention. An embodiment of the present invention could comprise means to pre-screen and shortlist candidates, based on a series of questions asked by a relevant industry expert, wherein at least part of the interaction between candidate and expert is recorded on video or other media and shared with a client for quick hiring decisions. This video/audio can be augmented with visual representations of the candidates resume data (skills, experience, successes etc.) and expert ratings.

The media comprising expert/candidate interaction can be divided into parts and indexed, thereby allowing, for example, each question or answer to be accessed and played on demand.

An embodiment of the present invention could comprise a procedure to effectively evaluate candidates for a position fit, using industry experts and recording interviews and resume visualizations.

Software in accordance with the present invention could receive input from various sources—including: client data, client resume, a subject matter expert—to assist in screening and selecting the best possible candidate(s) for a job requirement.

A business method in accordance with the present invention could comprise steps wherein a system running database management software:
accepts a set of inputs regarding an available job opening;
accepts data related to expert qualifications or candidate qualifications;
matches an industry expert (best match from database or client-selected expert) who can effectively evaluate a list of candidates for a good match for the job opening requirements;
accepts inputs provided by an expert regarding a candidate—said inputs could comprise a recorded video interview of the candidate conducted by the expert;
accepts weightings for each candidate evaluation criterion—criteria may come directly or indirectly from the client and/or from an expert; and
outputs information, possibly comprising rating(s) or a report, that can be used to make a decision regarding the best fit candidate(s) for the position.

In certain embodiments a database manager interacts with a subject matter expert to understand the client requirements and issues. A system running the software of the present invention receives the criteria, questions, and candidate interactions for the evaluation process. A subject matter expert can review requirements and refine the job posting. A system running software according to the present invention receives input relevant to conducting interactions with applicants. Such interactions may comprise interviews. The system records, processes, and stores applicant interactions.

Certain embodiments of the present invention may comprise visualization technology, such as graphics representing candidate data, ratings, or rankings. After ratings and rankings are calculated, the system running software in accordance with the present invention outputs a list of possible candidate matches along with formatted information relevant to candidate selection.

Candidate media recordings may be done locally or remotely.

The above examples of uses for embodiments of the present invention relate to matching potential employees with an open position. However, it should be appreciated that the present invention could serve other uses. A few examples are:

1. extracting, recording, formatting, and peer reviewing information from scientists and researchers to facilitate communication of information related to complex discoveries;

2. receiving, ranking, and organizing information and media related to employee skills and experience after corporate mergers or acquisitions to facilitate human resource decisions;

3. receiving, ranking, and organizing information and media related to employee skills and experience for ongoing career development;

4. receiving, ranking, and organizing information about student academic interests and accomplishments, extracurricular activities, and career goals for comparison against database of educational institution information for optimizing match of student to educational institution.

5. attracting and interviewing potential hires at a career fair and match potential hires with positions that fit best;

6. receiving, ranking, and organizing product review information for marketing or customer service;

7. receiving, ranking, and organizing information for educational use;

8. interactively conveying a concept to an audience;

9. producing recruiting videos for organizations etc.;

10. creating expert led profiles for students and executives or professionals

11. pre-screening candidates to fill various types of positions

12. generating instructional media for training people to accomplish complex tasks

13. recording and formatting customer support (e.g. help desk) interactions for quality control and so that relevant parts of an interaction can be accessed during follow up support (e.g. when a customer calls back for further assistance and is speaking to a different customer service representative); and

14. hosting a virtual job fair.

An example process in accordance with the present invention could comprise the following steps:

1. A system running software in accordance with the present invention receives a client's requirements;

2. the system receives parameters for selecting a relevant expert from an expert database, OR the system uses the client's requirements to generate the expert selection parameters and select a suitable expert from the expert database, OR the system receives required data for an expert selected by the client;

3. the system receives candidate selection parameters and assigns rankings to one or more candidates from the candidate database, OR the system uses the client's or expert's criteria to generate the candidate selection parameters and assigns a ranking to one or more suitable candidates from the candidate database;

4. the system receives inputs from selected expert and/or client for comparing candidate data to job requirements, receives or generates weighting for candidate data fit;

5. the system receives, records, formats, and indexes candidate-expert interactions in the database and receives and records subject matter expert's ranking of candidate output;

6. the system outputs a final list of candidates most fit for the selected inputs along with documentation justifying the choices;

7. preferably, the system will generate a profile that includes resume, references, assessment tests, background checks, visualization graphics of candidate qualifications, etc.

Potential sources for candidate database entries comprise: Industry sources, Recommendations or referrals from the subject matter expert, Field experts, skilled person knowledgeable and experienced in the industry, conduct interaction/interview with the set of questions created with interaction from the client/SME input etc. (Questions deemed to solicit information which will assist in selecting the optimum choice of solution/answers).

An embodiment of the present invention could work as follows:
The system comprises a set of databases, such as MySQL or similar, and associated rules
The logic is provided by using software code written in PHP/J2EE/.NET
The interface could comprise web pages having presentation specific code (in HTML/PHP code)
The system could comprise databases such as:
Job database that holds data received describing various job requirements and attributes, and additional information gleaned from client interviews
Candidate database comprising details about various candidates' skills, education, or experiences, etc. as well as any media (such as video interviews)
Expert database comprising details about various experts' skills, education, or experiences
Client database comprising data associated with various clients and their associated job requisitions, etc.
Interview questions database comprising interview questions received from the clients and experts along with associated job requirements and candidate data that would make each question relevant to a given candidate/job pairing.
Software code in accordance with the present invention would preferably handle the following tasks
Matching an Expert capable of reviewing and interviewing candidates with the job requisition. The associated data is accessed from the Job requisition and Expert database mentioned above.
Generating a list of interview questions from the Interview questions database which pertain to a specific job requisition interview
Receiving input from a database manager or a subject matter expert and adding it to the respective database (Interview questions or Candidate)
Generating a score for each candidate by following an algorithm having factors associated with the client's needs and the job requisition
Creating a list of candidate matches for a specific job requisition and generating a report for the job requisition
Accepting input from database managers, clients, experts, or clients and generating output and compiling it into a job requisition report

An embodiment of the present invention could comprise search engines for finding candidate data in the candidate database, finding expert data in the expert database, finding questions and question data in the question database, and finding open positions and job data in the job database. Such search engines would make it convenient to find a nexus of job data and candidate data and identify questions that are relevant to both the job and the candidate. Preferably, it would also be possible to find, review, and rank answers given in response to a question. In certain embodiments, media (e.g. video of candidates' answers) is linked to the question in the question database, and candidates' answers could thereby be compared.

Software according to the present invention could allow resumes to be more interactive, for example, by having clickable keywords to bring up requirements/placeholders in a resume, and having means to visualize resume data in various formats:
Resumes could accordingly comprise not just text, but diagrams illustrating a person's skills/experience
The software could enable innovative ways to display work samples as a part of solution
For technology positions—a media representation of people solving problems on computer
A framework for people to develop and provide plug-ins to create innovative resumes

Software in accordance with the present invention could provide technical data management and data visualization.

Software Workflow may comprise the following components:
Secure login
Summary, references, skills, linkedin, google search
Examples or samples of work on the next tab (media such as text/visual/video etc.)
Video of candidate troubleshooting a technical problem on the computer (only for technical positions)
Interview video clips with structured questions. Video can be disabled. (Video clips may be streamed or download-able; can be provided to client on request)
Audio clips can be used if video is not permitted
Interview transcripts can be used (if neither audio nor video is permitted)
The CLOUD TAG created for the person
Cloud elements can be linked to the resume or to the requirements
All questions and clips (video and audio) stored in database, and searchable by tags
Search engine/engine rules to find questions or candidate clips for a requirement
Other creative visualization techniques to showcase candidate

List of features (that may be used in various combinations):
Expert feedback
Video interview, audio interview, and/or transcript
Resume
Work samples (Reports, programs, software code, presentations, documents etc.)
Interactive Cloud tag of candidate resume or profile
Online tests (Technical and/or behavioral)
Other recommendations
Screen recording
Other inputs etc.

Students could use an embodiment of the present invention to share their profile for university applications. Embodiments of the present invention could be used for scientific research, R&D etc.

### BRIEF DESCRIPTIONS OF DRAWINGS

FIG. 1 describes an embodiment of the present invention.

FIG. 2 describes a recruiting-specific embodiment of the present invention.

FIG. 3 describes a simplified recruiting-specific embodiment of the present invention.

FIG. 4 describes a recruiting-specific embodiment of the present invention.

FIG. 5 describes a recruiting-specific embodiment of the present invention.

FIG. 6 describes an embodiment of the present invention for evaluating student performance in an academic institution.

FIG. 7 describes an embodiment of the present invention for college students evaluating potential academic institutions.

FIG. 8 describes an embodiment of the present invention for academic institutions evaluating potential admissions candidates.

FIG. 9 describes an embodiment of the present invention for literature review.

FIG. 10 describes an embodiment of the present invention for compiling documents containing knowledge of academic or industry specialists.

FIG. 11 describes an embodiment of the present invention that can be used as an HR tool for career development exercises for employees.

FIG. 12 describes an embodiment of the present invention that can be used evaluate and align assets during a merger or acquisition exercise by companies.

FIG. 13 describes an embodiment of the present invention that can be used for education and documentation of information using expert-led question and answer.

FIG. 14 describes a embodiment of the present invention that assists in evaluating contractors.

### DETAILED DESCRIPTIONS OF DRAWINGS

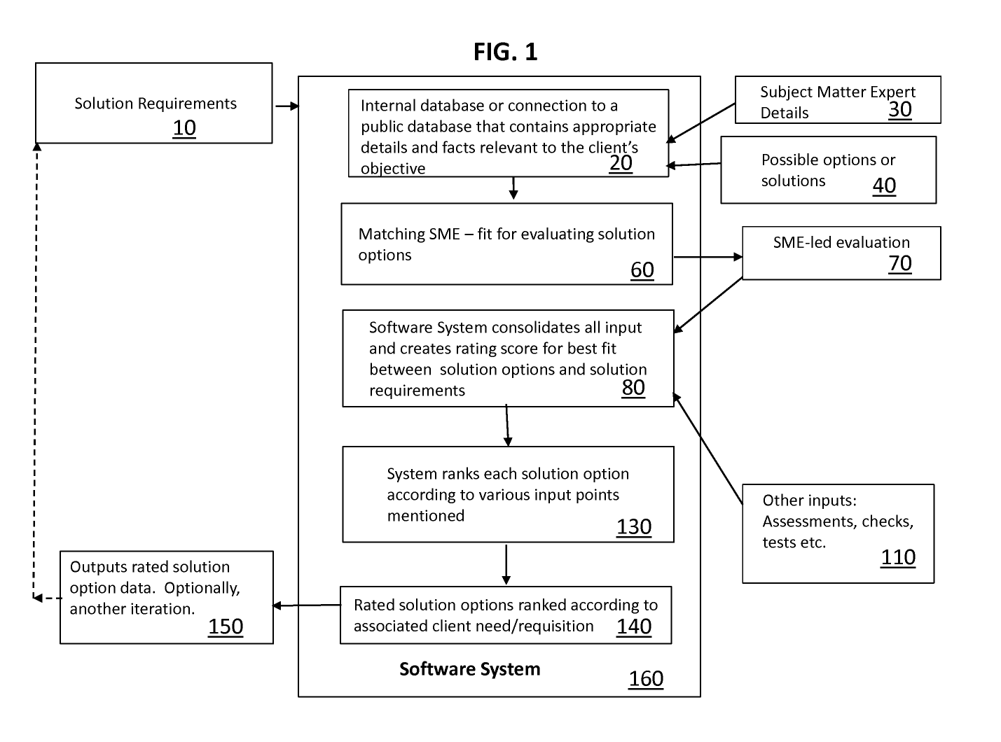

FIG. 1 describes an embodiment of the present invention, wherein the system running the software of the present invention 160 receives solution requirements 10 from the client. The system running the software of the present invention 160 comprises an internal database 20 or a connection to a public database 20 that contains appropriate details and facts relevant to the client's objective. The database further comprises information about experts, and these expert details 30 help match an expert with relevant expertise to the client's objective. The database 20 may further comprise possible options or solutions 40 from the user and/or other public sources. The user may comprise a database manager or an expert. The database 20 may have received the expert details 30 and possible solution options 40 before or after the system running the software of the present invention 160 receives solution requirements 10 from the client, or they may be retrieved from the user or other public sources. In step 60, the system running the software of the present invention 160 selects an expert suitable for evaluating the solution options based on expert skills, background, and/or availability or other factors relevant to the solution requirements and provides the collected information to the user for an expert led evaluation 70 of the solution options 40. The system running the software of the present invention 160 receives inputs from the expert-led evaluation 70. The system running the software of the present invention 160 can also receive additional information 110 from assessments, checks, tests, etc. The system running the software of the present invention 160 consolidates all input and creates a rating score 80 to describe the best fit between the solution options 40 and the solution requirements 10. In the step 130, the system running the software of the present invention 160 ranks each solution option 40 according to the various inputs described above, including from the expert-led evaluation 70 and the optional inputs 110, and the relative weighting specified by the user, expert, or client. In step 140, the system running the software of the present invention 160 determines the ranked solution options 40 that best satisfy the associated client solution requirements 10. The system running the software of the present invention 160 returns these evaluated solution options 150 to the client. The evaluated solution options 150 may comprise a consolidated list of relevant information, a ranked list of all solution options, a ranked list of a previously-specified number of solution options, or a list of solution options that meet certain specified criteria. The client would then be able to review these options 150 and leave the process flow if a satisfactory solution was identified, or re-enter the process flow if a satisfactory solution was not identified. If the process flow is reentered, the system running the software of the present invention 160 receives new input and another iteration of the above steps is executed.

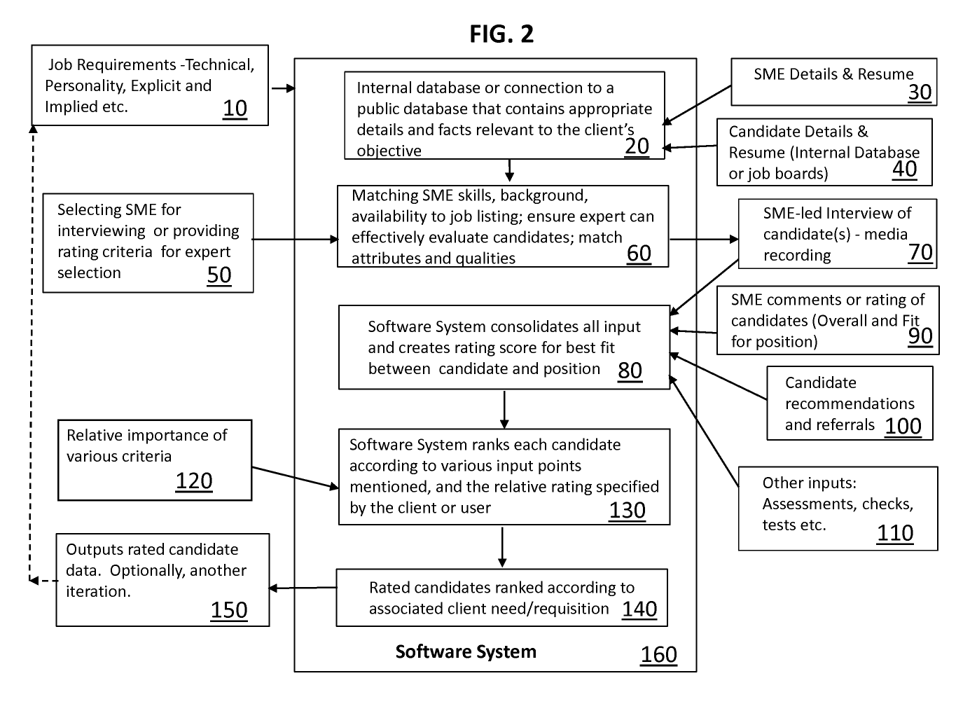

FIG. 2 describes a recruiting-specific embodiment of the present invention. The client inputs the job requirements 10, comprising various required explicit or implied candidate qualities such as technical knowledge, personality, etc. into the system running the software of the present invention 160. The system running the software of the present invention 160 comprises an internal database 20 or a connection to a public database that contains appropriate details and facts relevant to the client's objective. The database further comprises information about experts who could review these candidates. These expert details and resume 30 help match an expert with relevant expertise to the client's objective. The database 20 may further comprise candidate details and resumes 40 from the user or other public sources, including internal databases or job boards. In step 60, the system running the software of the present invention 160 selects an expert suitable for evaluating the candidates based on expert skills, background, and/or availability to the job listing requirements. Alternatively, the client may select an expert for evaluating the candidates. The client may provide relative weighting of criteria 50. The system running the software of the present invention 160 provides the collected information to the user for expert-led interviews 70 of the candidates 40. The interviews 70 of the candidates 40 may be video or audio recorded for future referencing. The system running the software of the present invention 160 receives input from the expert-led interviews 70. Said inputs may comprise expert comments or ratings 90 of the candidate 40. The system running the software of the present invention 160 can also receive candidate recommendations and referrals 102 or additional information 110 from assessments, checks, tests, etc. The system running the software of the present invention 160 consolidates all input and creates a rating score 80 to describe the best fit between the candidates 40 and the job requirements 10. In the step 130, the system running the software of the present invention 160 ranks each candidate 40 according to the various inputs described above, comprising the expert-led interview 70, expert comments or ratings 90 of the candidates, the candidate recommendations and referrals 100, and the additional inputs 110, and the relative weighting 120 specified by the client, expert, or user. In step 140, the system running the software of the present invention 160 determines the top rated candidates 40 and selects a number of options previously requested by the client that best satisfy the associated client job requirements 10. The system running the software of the present invention 160 returns these top-rated, or shortlisted, options 150 to the client. The client would then be able to review the shortlisted candidates 150 and leave the process flow if a satisfactory candidate was identified, or re-enter the process flow if a satisfactory candidate was not identified. If the process flow is reentered, the system running the software of the present invention 160 receives new input and another iteration of the above steps is executed.

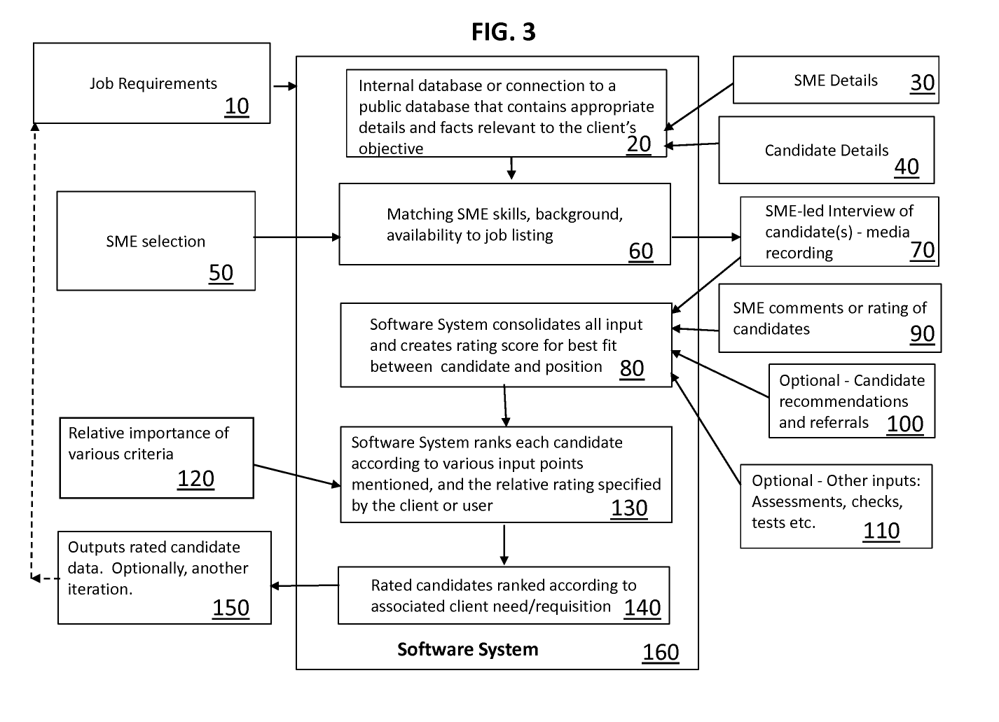

FIG. 3 describes a simplified recruiting-specific embodiment of the present invention. The client inputs his/her job requirements 13 into the system running the software of the present invention 160. The system running the software of the present invention 160 comprises an internal database 22 or a connection to a public database that contains appropriate details and facts relevant to the client's objective. The database further comprises information about experts who could review these candidates and these expert details 33 help match an expert with relevant expertise to the client's objective. The database 22 may further comprise candidate details 43 from the user or other public sources. In step 62, the system running the software of the present invention 160 selects an expert suitable for evaluating the candidates based on expert skills, background, and/or availability to the job listing requirements. Alternatively, the system running the software of the present invention 160 may receive the client's selection of an expert for evaluating the candidates 53. The system running the software of the present invention 160 provides the collected information to the user for expert-led interviews 72 of the candidates. The evaluation 72 may comprise interviews of the candidates that are video or audio recorded for future referencing. The system running the software of the present invention 160 receives inputs from the expert-led interviews 72 and expert comments or ratings 92 of the candidate. Optionally, the system running the software of the present invention 160 can also receive candidate recommendations and referrals 102 or additional information 110 from assessments, checks, tests, etc. The system running the software of the present invention 160 consolidates all input and creates a rating score 82 to describe the best fit between the candidates 42 and the job requirements 13. In the step 132, the system running the software of the present invention 160 ranks each candidate according to the various inputs described above, comprising input from the expert-led interview 72, expert comments or ratings 92 of the candidates, the optional candidate recommendations and referrals 102, and the optional additional inputs 110, and the relative weighting specified by the client 122, expert, or user. In step 142, the system running the software of the present invention 160 determines the top rated candidates and selects a number of options previously requested by the client that best satisfy the associated client job requirements 13. The system running the software of the present invention 160 returns these top-rated, or shortlisted, options 152 to the client. The client would then be able to review the shortlisted candidates 152 and leave the process flow if a satisfactory candidate was identified, or re-enter the process flow if a satisfactory candidate was not identified. If the process flow is reentered, the system running the software of the present invention 160 receives new input and another iteration of the above steps is executed.

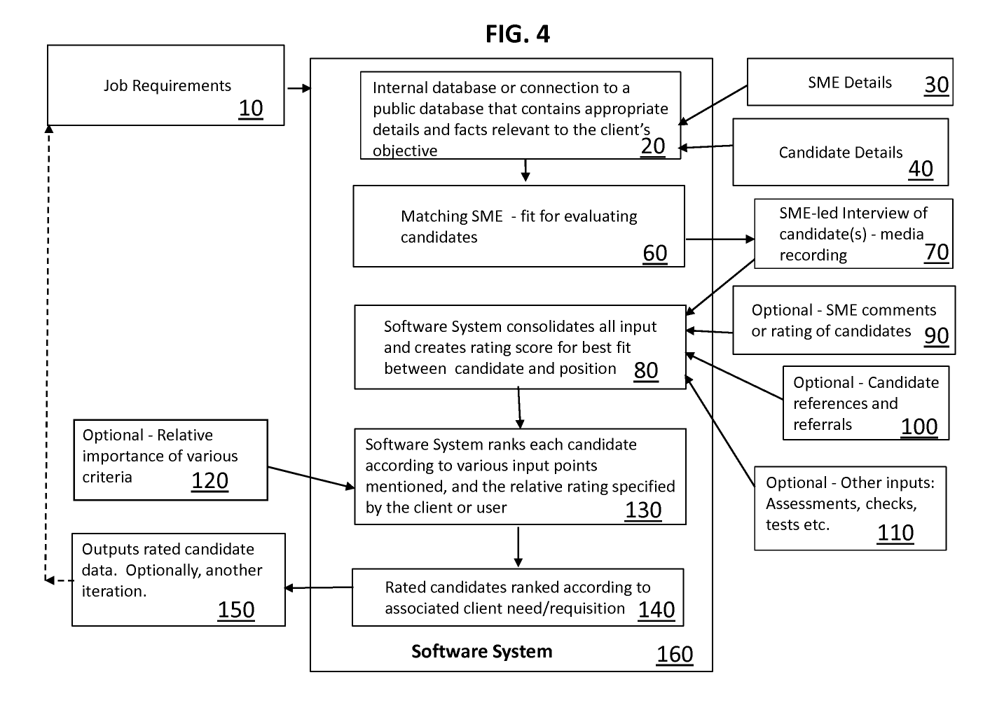

FIG. 4 describes a recruiting-specific embodiment of the present invention. The client inputs his/her job requirements 13 into the system running the software of the present invention 160. The system running the software of the present invention 160 comprises an internal database 22 or a connection to a public database that contains appropriate details and facts relevant to the client's objective. The database further comprises information about experts who could review these candidates and these expert details 33 help match an expert with relevant expertise to the client's objective. The database 22 may further comprise candidate details 43 from the user or other public sources. In step 63, the system running the software of the present invention 160 selects an expert suitable for evaluating the candidates. The system running the software of the present invention 160 provides the collected information to the user for expert-led interviews 72 of the candidates. The evaluation 72 may include interviews of the candidates that are video or audio recorded for future referencing. The system running the software of the present invention 160 receives inputs from the expert-led interviews 72 and expert comments or ratings 92 of the candidates. Optionally, the system running the software of the present invention 160 can also receive candidate recommendations and referrals 102 or additional information 110 from assessments, checks, tests, etc. The system running the software of the present invention 160 consolidates all input and creates a rating score 82 to describe the best fit between the candidates 42 and the job requirements 13. In the step 132, the system running the software of the present invention 160 ranks each candidate according to the various inputs described above, including from the expert-led interview 72, expert comments or ratings 92 of the candidates, the optional candidate recommendations and referrals 102, and the optional additional inputs 110, and the relative weighting specified by the client 122, expert, or user. In step 142, the system running the software of the present invention 160 determines the top rated candidates and selects a number of options previously requested by the client that best satisfy the associated client job requirements 13. The system running the software of the present invention 160 returns these top-rated, or shortlisted, options 152 to the client. The client would then be able to review the shortlisted candidates 152 and leave the process flow if a satisfactory candidate was identified, or re-enter the process flow if a satisfactory candidate was not identified. If the process flow is reentered, the system running the software of the present invention 160 receives new input and another iteration of the above steps is executed.

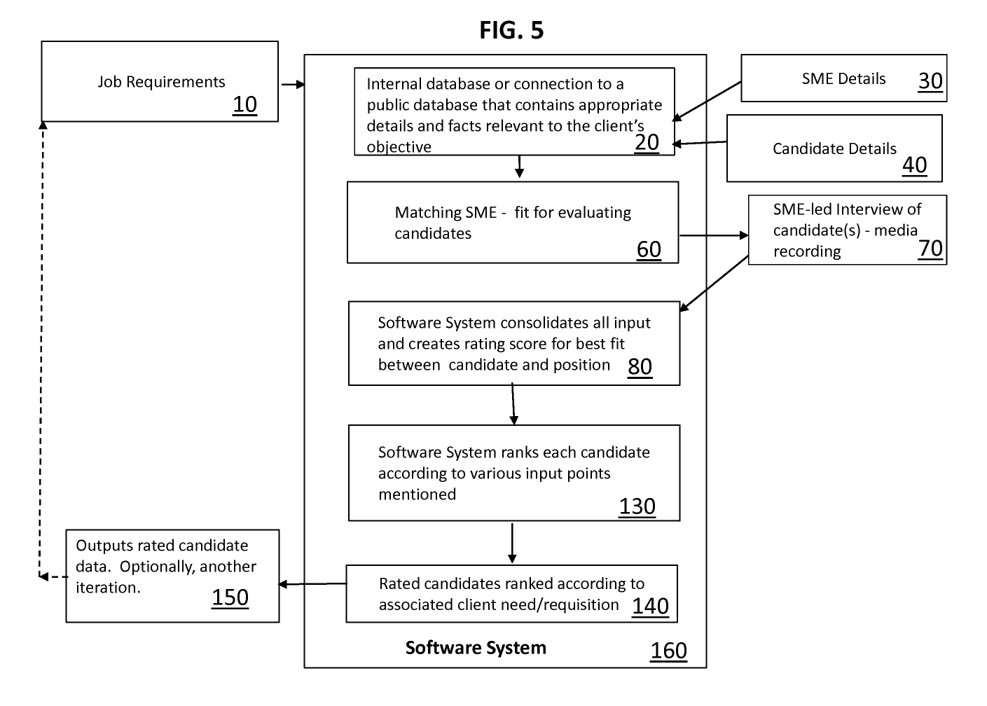

FIG. 5 describes a recruiting-specific embodiment of the present invention. The client inputs his/her job requirements 13 into the system running the software of the present invention 160. The system running the software of the present invention 160 comprises an internal database 22 or a connection to a public database that contains appropriate details and facts relevant to the client's objective. The database further comprises information about experts who could review these candidates and these expert details 33 help match an expert with relevant expertise to the client's objective. The database 22 may further comprise candidate details 43 from the user or other public sources. In step 63, the system running the software of the present invention 160 selects an expert suitable for evaluating the candidates. The system running the software of the present invention 160 provides the collected information to the user for expert-led interviews 72 of the candidates. The evaluation 72 may include interviews of the candidates that are video or audio recorded for future referencing. The system running the software of the present invention 160 receives inputs from the expert-led interviews. The system running the software of the present invention 160 consolidates all input and creates a rating score 82 to describe the best fit between the candidates 42 and the job requirements 13. In the step 132, the system running the software of the present invention 160 ranks each candidate according to the various inputs described above, including from the expert-led interview 72. In step 142, the system running the software of the present invention 160 determines the top rated candidates and selects a number of options previously requested by the client that best satisfy the associated client job requirements 13. The system running the software of the present invention 160 returns these top-rated, or shortlisted, options 152 to the client. The client would then be able to review the shortlisted candidates 152 and leave the process flow if a satisfactory candidate was identified, or re-enter the process flow if a satisfactory candidate was not identified. If the process flow is reentered, the system running the software of the present invention 160 receives new input and another iteration of the above steps is executed.

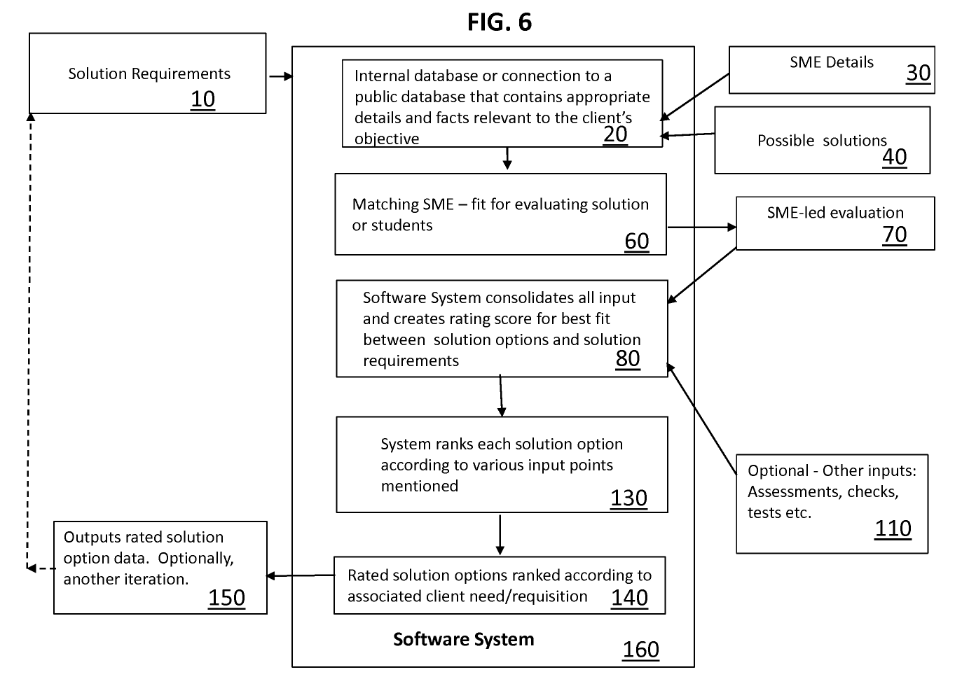

FIG. 6 describes an embodiment of the present invention for evaluating student performance in an academic institution, wherein the system running the software of the present invention 160 receives solution requirements 10 from the client, wherein the client may comprise an academic institution. This embodiment may also be applied to evaluating military or career training exercises. The system running the software of the present invention 160 comprises an internal database 20 or a connection to a public database 20 that contains appropriate details and facts relevant to the client's objective. The database further comprises information about experts, and these expert details 30 help match an expert with relevant expertise to the client's objective. The database 20 may further comprise possible options or solutions 40 from the user and/or other public sources. The user may comprise a database manager or an expert. The database 20 may have received the expert details 30 and possible solution options 40 before or after the system running the software of the present invention 160 receives solution requirements 10 from the client, or they may be retrieved from the user or other public sources. In step 60, the system running the software of the present invention 160 selects an expert suitable for evaluating the solutions or students based on expert skills, background, and/or availability or other factors relevant to the solution requirements and provides the collected information to the user for an expert-led evaluation 70 of the solution options 40. The system running the software of the present invention 160 receives inputs from the expert-led evaluation 70. The system running the software of the present invention 160 can also receive additional information 110 from assessments, checks, tests, etc. The system running the software of the present invention 160 consolidates all input and creates a rating score 80 to describe the best fit between the solution options 40 and the solution requirements 10. In the step 130, the system running the software of the present invention 160 ranks each solution option 40 according to the various inputs described above, including from the expert-led evaluation 70 and the optional inputs 110. In step 140, the system running the software of the present invention 160 determines the ranked solution options 40 that best satisfy the associated client solution requirements 10. The system running the software of the present invention 160 returns these evaluated solution options 150 to the client. The evaluated solution options 150 may comprise a consolidated list of relevant information, a ranked list of all solution options, a ranked list of a previously-specified number of solution options, or a list of solution options that meet certain specified criteria. The client would then be able to review these options 150 and leave the process flow if a satisfactory solution was identified, or re-enter the process flow if a satisfactory solution was not identified. If the process flow is reentered, the system running the software of the present invention 160 receives new input and another iteration of the above steps is executed.

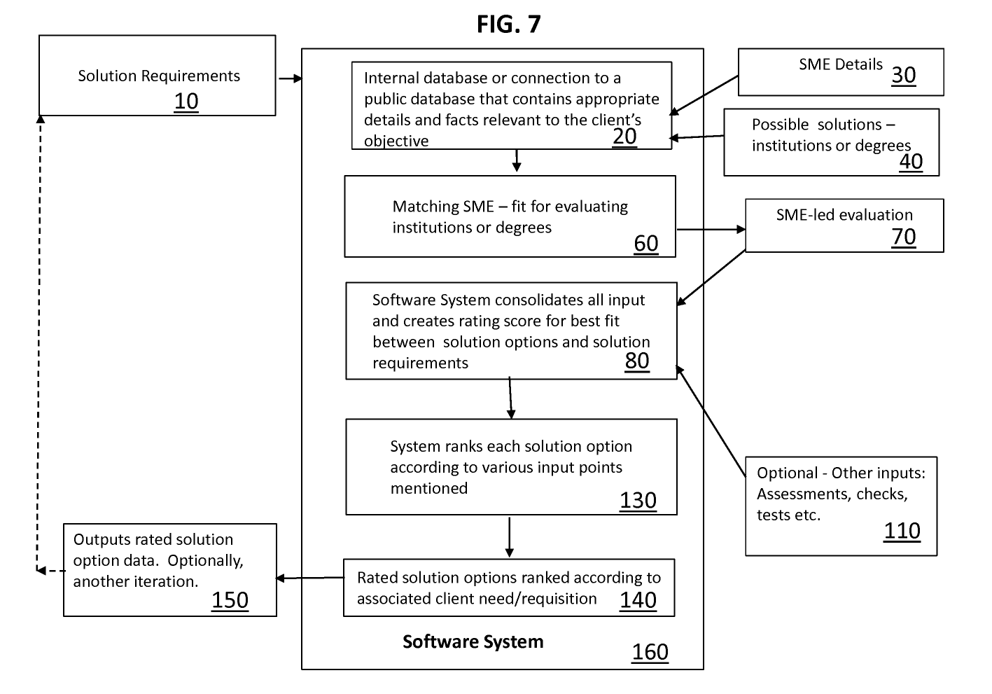

FIG. 7 describes an embodiment of the present invention for college students evaluating potential academic institutions, wherein the system running the software of the present invention 160 receives solution requirements 10 from the client, wherein a client may comprise a student. The system running the software of the present invention 160 comprises an internal database 20 or a connection to a public database 20 that contains appropriate details and facts relevant to the client's objective. The database further comprises information about experts, and these expert details 30 help match an expert with relevant expertise to the client's objective. The expert details 30 and institutions or degrees 40 may have been entered into the database 20 before or after the system running the software of the present invention 160 receives solution requirements 10 from the client, or they may be retrieved from the user or other public sources. The database 20 may further comprise possible institutions or degrees 40 from the user and/or other public sources. In step 60, the system running the software of the present invention 160 selects an expert suitable for evaluating the solution options based on expert skills, background, and/or availability or other factors relevant to the solution requirements and provides the collected information to the user for an expert-led evaluation 70 of the institutions or degrees 40. The system running the software of the present invention 160 receives inputs from the expert-led evaluation 70. The system running the software of the present invention 160 can also receive optional additional information 110 from assessments, checks, tests, etc. The system running the software of the present invention 160 consolidates all input and creates a rating score 80 to describe the best fit between the solution options 40 and the solution requirements 10. In the step 130, the system running the software of the present invention 160 ranks each institution or degree 40 according to the various inputs described above, including from the expert-led evaluation 70 and the optional inputs 110, and the relative weighting specified by the user, expert, or client. In step 140, the system running the software of the present invention 160 determines the top rated institutions or degrees 40 and selects a number of options previously requested by the client that best satisfy the associated client solution requirements 10. The system running the software of the present invention 160 returns these top-rated, or shortlisted, options 150 to the client. The client would then be able to review the shortlisted options 150 and leave the process flow if a satisfactory solution was identified, or re-enter the process flow if a satisfactory solution was not identified. If the process flow is reentered, the system running the software of the present invention 160 receives new input and another iteration of the above steps is executed.

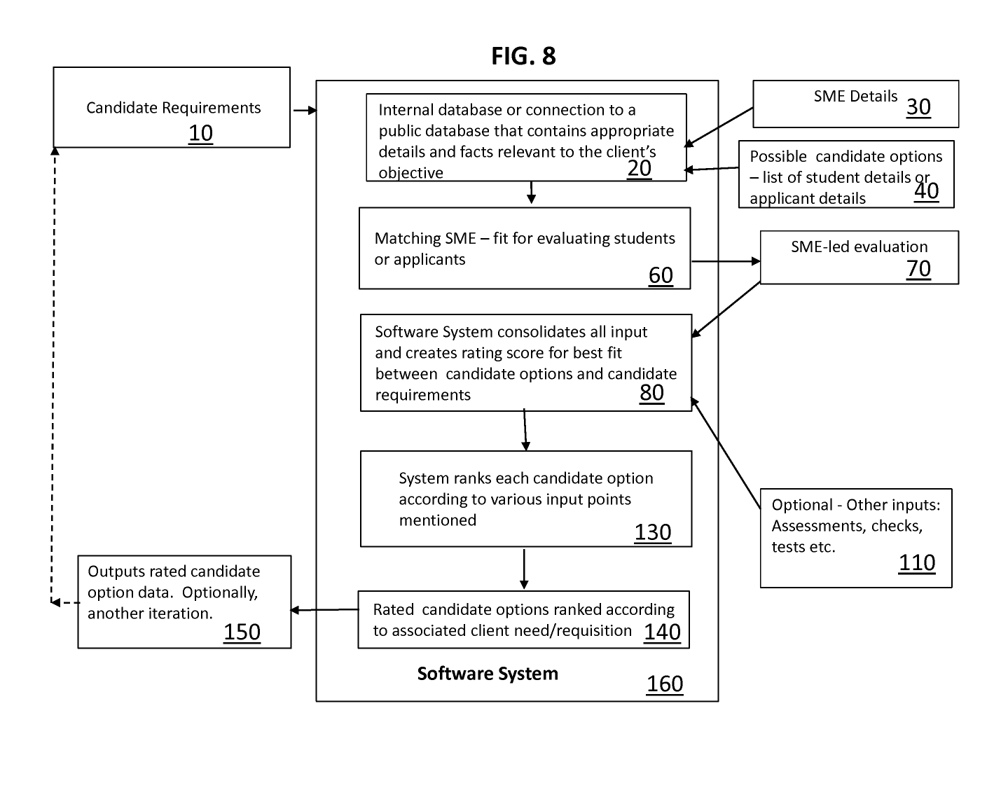

FIG. 8 describes an embodiment of the present invention for academic institutions evaluating potential admissions candidates, wherein the system running the software of the present invention 160 receives candidate requirements 10 from the client, wherein a client may comprise an academic institution. This embodiment may also apply to military institutions recruiting enlisted or officer personnel. The system running the software of the present invention 160 comprises an internal database 20 or a connection to a public database 20 that contains appropriate details and facts relevant to the client's objective. The database further comprises information about experts, and these expert details 30 help match an expert with relevant expertise to the client's objective. The expert details 30 and list of applicants 40 may have been entered into the database 20 before or after the system running the software of the present invention 160 receives solution requirements 10 from the client, or they may be retrieved from the user or other public sources. The database 20 may further comprise possible applicants 40 from the user and/or other public sources. In step 60, the system running the software of the present invention 160 selects an expert suitable for evaluating the applicants or student based on expert skills, background, and/or availability or other factors relevant to the candidate requirements 10 and provides the collected information to the user for an expert-led evaluation 70 of the applicants 40.

The system running the software of the present invention 160 receives inputs from the expert-led evaluation 70. Said inputs may comprise expert comments or ratings 90 of the applicant 40. The system running the software of the present invention 160 can also receive optional additional information 110 from assessments, checks, tests, etc. The system running the software of the present invention 160 consolidates all input and creates a rating score 80 to describe the best fit between the solution options 40 and the candidate requirements 10. In the step 130, the system running the software of the present invention 160 ranks each applicant 40 according to the various inputs described above, including from the expert-led evaluation 70, expert comments or ratings 90 of the candidates, and the optional inputs 110, and the relative weighting specified by the user, expert, or client. In step 140, the system running the software of the present invention 160 determines the top rated applicants 40 and selects a number of options previously requested by the client that best satisfy the associated client candidate requirements 10. The system running the software of the present invention 160 returns these top-rated, or shortlisted, options 150 to the client. The client would then be able to review the shortlisted options 150 and leave the process flow if a satisfactory solution was identified, or re-enter the process flow if a satisfactory solution was not identified. If the process flow is reentered, the system running the software of the present invention 160 receives new input and another iteration of the above steps is executed.

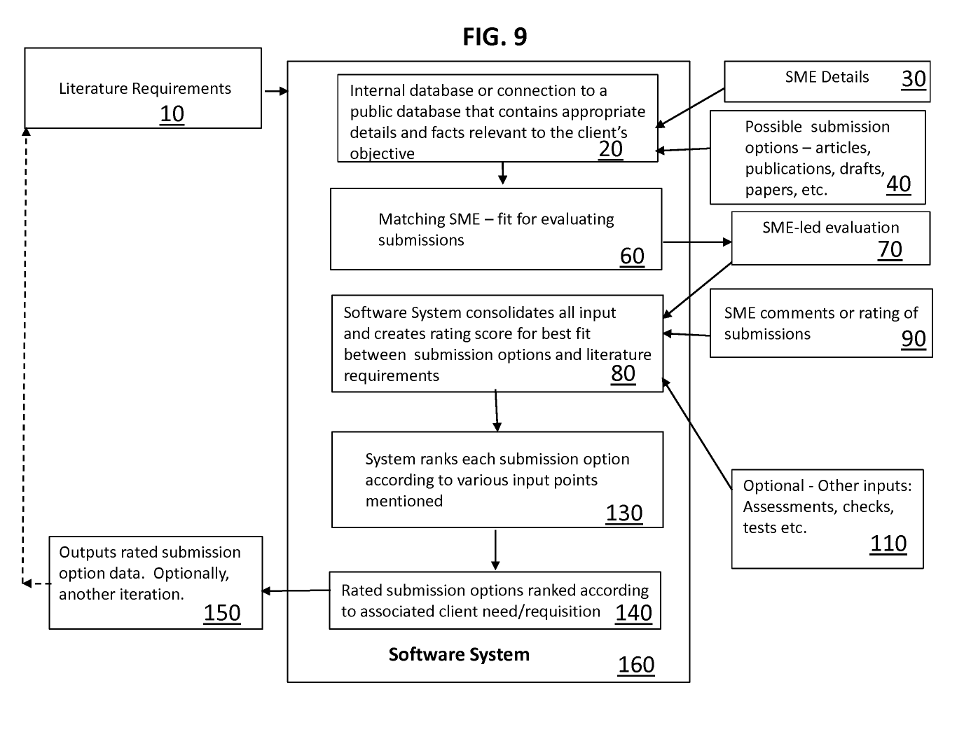

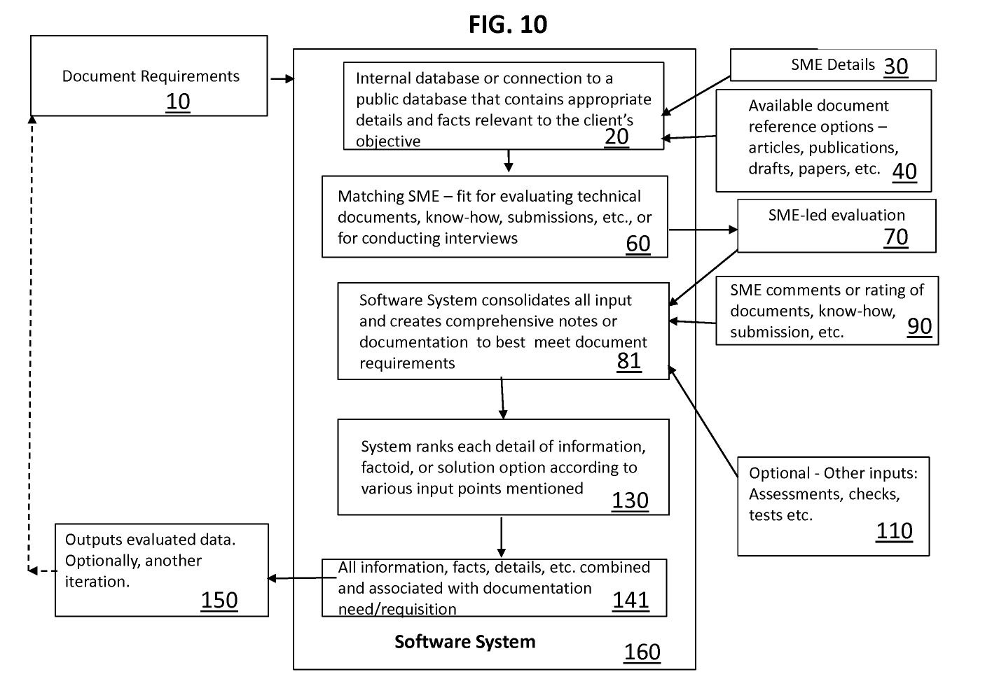

FIG. 9 describes an embodiment of the present invention for literature review, wherein the system running the software of the present invention 160 receives literature requirements 10 from the client. The system running the software of the present invention 160 comprises an internal database 20 or a connection to a public database 20 that contains appropriate details and facts relevant to the client's objective, including articles, publications, drafts, etc. The database further comprises information about experts, and these expert details 30 help match an expert with relevant expertise to the client's objective. The expert details 30 and possible literature options 40 may have been entered into the database 20 before or after the system running the software of the present invention 160 receives literature requirements 10 from the client, or they may be retrieved from the user or other public sources. The database 20 may further comprise possible literature options 40 from the user and/or other public sources. In step 60, the system running the software of the present invention 160 selects an expert suitable for evaluating the submissions based on expert skills, background, and/or availability or other factors relevant to the literature requirements and provides the collected information to the user for an expert-led evaluation 70 of the submission 40. The system running the software of the present invention 160 receives inputs from the expert-led evaluation 70. Said inputs may comprise expert comments or ratings 90 of the submission 40. The system running the software of the present invention 160 can also receive optional additional information 110 from assessments, checks, tests, etc. The system running the software of the present invention 160 consolidates all input and creates a rating score 80 to describe the best fit between the submission 40 and the literature requirements 10. In the step 130, the system running the software of the present invention 160 ranks each submission 40 according to the various inputs described above, including from the expert-led evaluation 70, expert comments or ratings 90 of the submission, and the optional inputs 110, and the relative weighting specified by the user, expert, or client. In step 140, the system running the software of the present invention 160 determines the top rated submission 40 and selects a number of options previously requested by the client that best satisfy the associated client literature requirements 10. The system running the software of the present invention 160 returns these top-rated, or shortlisted, options 150 to the client. The client would then be able to review the shortlisted options 150 and leave the process flow if a satisfactory solution was identified, or re-enter the process flow if a satisfactory solution was not identified. If the process flow is reentered, the system running the software of the present invention 160 receives new input and another iteration of the above steps is executed. FIG. 10 describes an embodiment of the present invention for compiling documents containing knowledge of academic or industry specialists, wherein the system running the software of the present invention 160 receives document requirements 10 from the client. The academic or industry specialists may comprise research and development specialists, laboratory scientists, or subject matter experts.

The system running the software of the present invention 160 comprises an internal database 20 or a connection to a public database 20 that contains appropriate details and facts relevant to the client's objective, including articles, publications, drafts, etc. The database further comprises information about experts, and these expert details 30 help match an expert with relevant expertise to the client's objective. The expert details 30 and possible document options 40 may have been entered into the database 20 before or after the system running the software of the present invention 160 receives document requirements 10 from the client, or they may be retrieved from the user or other public sources. The database 20 may further comprise possible literature options 40 from the user and/or other public sources. In step 60, the system running the software of the present invention 160 selects an expert suitable for reviewing technical documents and submissions, interviewing specialists, and evaluating specialists' knowledge based on expert skills, background, and/or availability or other factors relevant to the document requirements and provides the collected information to the user for an expert-led evaluation 70 of the specialists and available documents 40. The system running the software of the present invention 160 receives inputs from the expert-led evaluation 70. Said inputs may comprise expert comments or ratings 90 of the specialists' knowledge and available documents 40.

The system running the software of the present invention 160 can also receive optional additional information 110 from assessments, checks, tests, etc. The system running the software of the present invention 160 consolidates all input and creates comprehensive notes and documentation 80 to describe the best fit between the document 40 and the document requirements 10. In the step 130, the system running the software of the present invention 160 ranks each details, factoid, or solution option according to the various inputs described above, including from the expert-led evaluation 70, expert comments or ratings 90 of the submission, and the optional inputs 110, and the relative weighting specified by the user, expert, or client. In step 140, the system running the software of the present invention 160 determines the top rated details, factoids, or solution options and selects a number of options previously requested by the client that best satisfy the associated client document requirements 10. The system running the software of the present invention 160 returns these top-rated, or shortlisted, options 150 to the client. The client would then be able to review the shortlisted options 150 and leave the process flow if a satisfactory solution was identified, or re-enter the process flow if a satisfactory solution was not identified. If the process flow is reentered, the system running the software of the present invention 160 receives new input and another iteration of the above steps is executed.

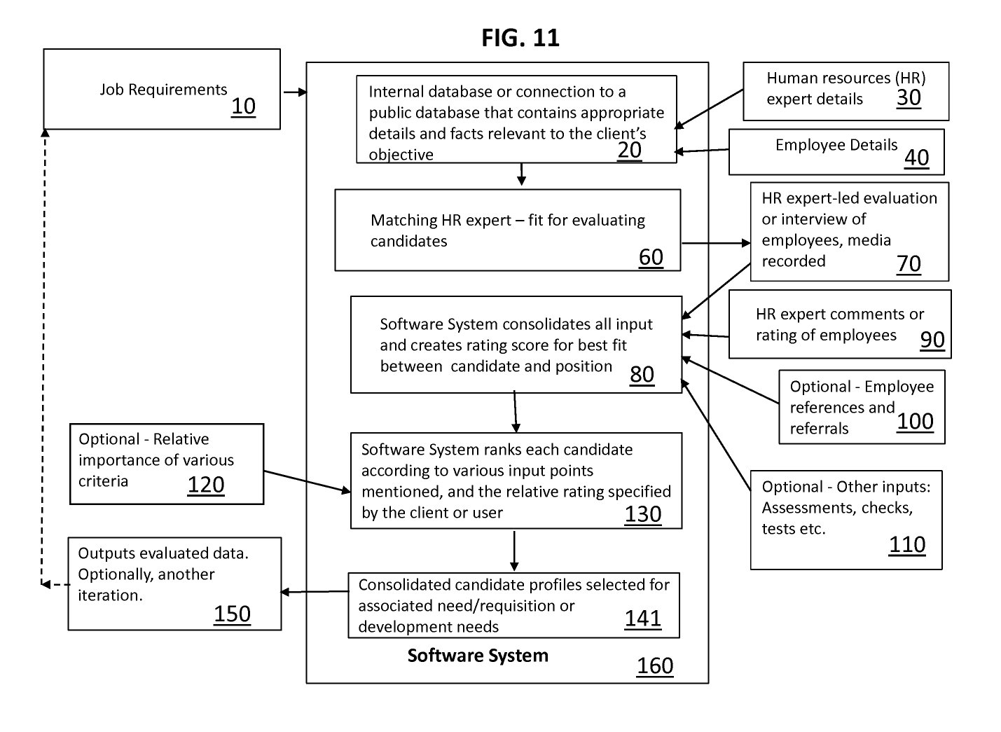

FIG. 11 describes an embodiment of the present invention that can be used as an HR tool for career development exercises for employees. The client inputs his/her job requirements 10 into the system running the software of the present invention 160. The system running the software of the present invention 160 comprises an internal database 20 or a connection to a public database that contains appropriate details and facts relevant to the client's objective. The database further comprises information about experts who could review these candidates. These human resources expert details 30 help match an expert with relevant expertise to the client's objective. The database 20 may further comprise employee details 40 from the user or other public sources. In step 60, the system running the software of the present invention 160 selects an expert suitable for evaluating the candidates based on expert skills, background, and/or availability to the job requirements. The system running the software of the present invention 160 provides the collected information to the user for expert-led interviews 70 of the employees. The interviews 70 of the employees may be video or audio recorded for future referencing. The system running the software of the present invention 160 receives input from the expert-led interviews 70. Said inputs may optionally comprise expert comments or ratings 90 of the employees. The system running the software of the present invention 160 can also receive optional employee recommendations and referrals 100 or optionally additional information 110 from assessments, checks, tests, etc. The system running the software of the present invention 160 consolidates all input and creates a rating score 80 to describe the best fit between the employees and the job requirements 10. In the step 130, the system running the software of the present invention 160 ranks each employee according to the various inputs described above, comprising the expert-led interview 70, optional expert comments or ratings 90 of the candidates, the optional candidate recommendations and referrals 100, and the optional additional inputs 110, and optionally the relative weighting 120 specified by the client, expert, or user. In step 140, the system running the software of the present invention 160 consolidates employee profiles and development needs and selects a number of options previously requested by the client that best satisfy the associated client job requirements 10.

The system running the software of the present invention 160 returns these consolidated employee profiles and development needs 150 to the client. The client would then be able to review the consolidated employee profiles and development needs 150 and leave the process flow if a satisfactory solution was identified, or re-enter the process flow if a satisfactory solution was not identified. If the process flow is reentered, the system running the software of the present invention 160 receives new input and another iteration of the above steps is executed.

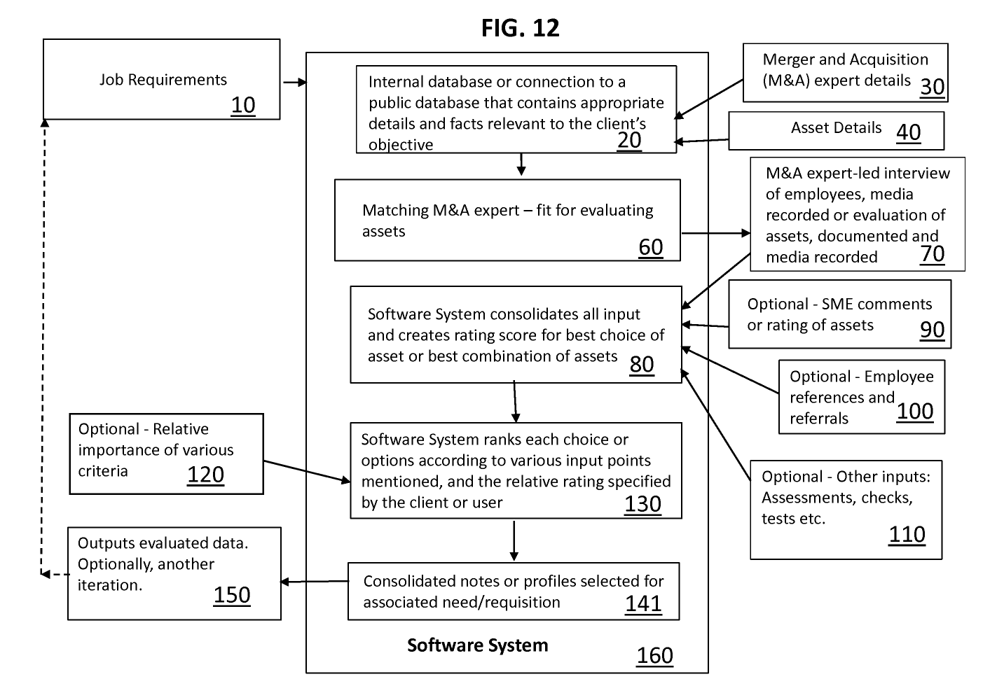

FIG. 12 describes an embodiment of the present invention that can be used evaluate and align assets during a merger or acquisition exercise by companies. The client inputs his/her job requirements 10 into the system running the software of the present invention 160. The system running the software of the present invention 160 comprises an internal database 20 or a connection to a public database that contains appropriate details and facts relevant to the client's objective, wherein the details and facts may comprise information about assets, employees, departments, tangibles, etc. The database further comprises information about experts who could review these assets. These merger and acquisition expert details 30 help match an expert with relevant expertise to the client's objective. The database 20 may further comprise asset details 40 from the user or other public sources. In step 60, the system running the software of the present invention 160 selects an expert suitable for evaluating the assets based on expert skills, background, and/or availability to the job requirements. The system running the software of the present invention 160 provides the collected information to the user for expert-led interviews 70 of employees or expert-led evaluations 70 of assets. The interviews 70 of the employees may be video or audio recorded for future referencing and the evaluations 70 may be recorded and documented for future referencing. The system running the software of the present invention 160 receives input from the expert-led interviews or evaluations 70. Said inputs may optionally comprise expert comments or ratings 90 of the assets. The system running the software of the present invention 160 can also receive optional employee recommendations and referrals 100 or optional additional information 110 from assessments, checks, tests, etc. The system running the software of the present invention 160 consolidates all input and creates a rating score 80 to describe the best fit between the assets and the job requirements 10 or the best combination of assets to fit the job requirement 10. In the step 130, the system running the software of the present invention 160 ranks each employee according to the various inputs described above, comprising the expert-led interview 70, optional expert comments or ratings 90 of the assets, the optional employee recommendations and referrals 100, and the optional additional inputs 110, and optionally the relative weighting 120 specified by the client, expert, or user. In step 140, the system running the software of the present invention 160 consolidates the notes, profiles, and asset selections and selects options that best satisfy the associated client job requirements 10. The system running the software of the present invention 160 returns these shortlisted options 150 to the client. The client would then be able to review the shortlisted options 150 and leave the process flow if a satisfactory option was identified, or re-enter the process flow if a satisfactory option was not identified. If the process flow is reentered, the system running the software of the present invention 160 receives new input and another iteration of the above steps is executed.

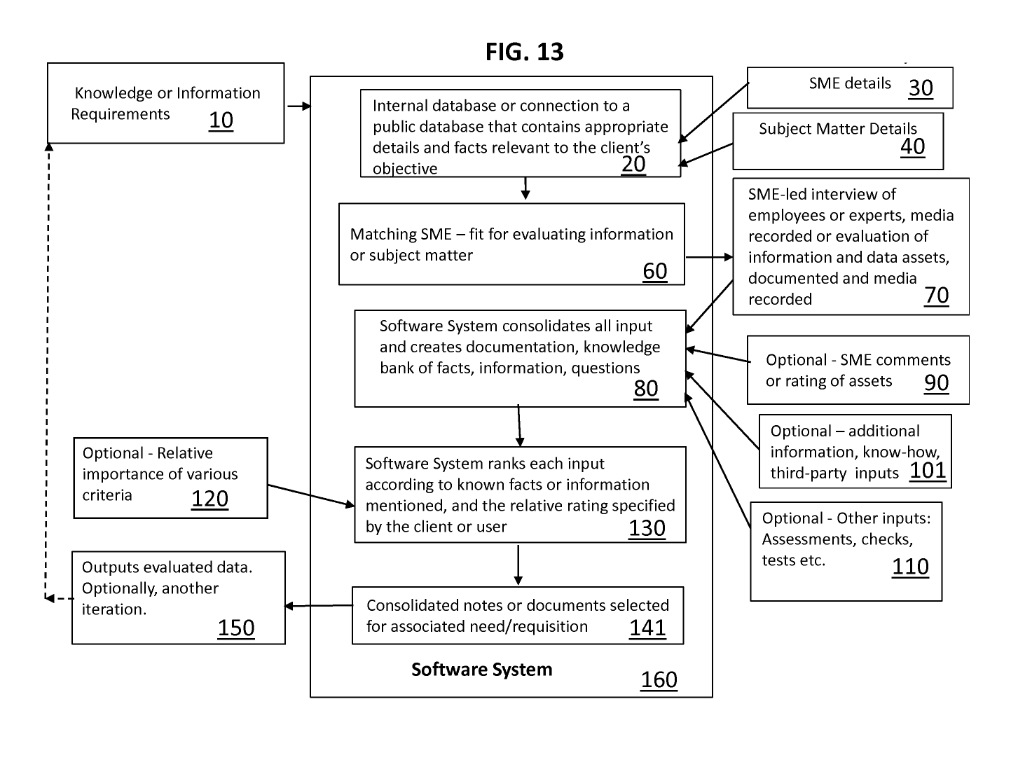

FIG. 13 describes an embodiment of the present invention that can be used for education and documentation of information using expert-led question and answer. This embodiment may comprise a seminar situation, where students may observe the interaction between a knowledge seeker and a domain expert. This embodiment may also be used in a new interviewing situation, in which the client seeking knowledge may comprise a journalist and the expert may comprise a field expert. The client inputs his/her knowledge or information requirements 10 into the system running the software of the present invention 160. The system running the software of the present invention 160 comprises an internal database 20 or a connection to a public database that contains appropriate details and facts relevant to the client's objective, wherein the details and facts may comprise information about domain industry, terminology, etc. The database further comprises information about experts who could review this knowledge or information. These domain expert details 30 help match an expert with relevant expertise to the client's objective. The database 20 may further comprise subject matter details 40 from the user or other public sources. In step 60, the system running the software of the present invention 160 selects an expert suitable for evaluating the information based on expert skills, background, and/or availability to the knowledge or information requirements 10. The system running the software of the present invention 160 provides the collected information to the user for expert-led interviews 70 of experts or employees or expert-led evaluations 70 of information or data assets. The interviews 70 of the experts or employees may be video or audio recorded for future referencing and the evaluations of information or data assets 70 may be recorded and documented for future referencing. The system running the software of the present invention 160 receives input from the expert-led interviews or evaluations 70. Said inputs may optionally comprise expert comments or ratings 90 of the experts, employees, information, or data assets. The system running the software of the present invention 160 can also receive optional third-party information or know-how input 100 or optional additional information 110 from assessments, checks, tests, etc. The system running the software of the present invention 160 consolidates all input and creates knowledge bank comprising facts, information, and questions 80. In the step 130, the system running the software of the present invention 160 evaluates each input comprising the expert-led interview or evaluation 70, optional expert comments or ratings 90 of the experts, employees, information, or data assets, the optional third party information 100, and the optional additional inputs 110 according to the known facts or information, and the optional relative weighting 120 specified by the client, expert, or user. In step 140, the system running the software of the present invention 160 consolidates the top rated notes, profiles, and asset selections and selects the consolidated notes and documentation that best satisfy the associated client knowledge or information requirements 10. The system running the software of the present invention 160 returns these consolidated notes and documentation 150 to the client. The client would then be able to review the consolidated notes and documentation 150 and leave the process flow if satisfactory information was identified, or re-enter the process flow if satisfactory information was not identified. If the process flow is reentered, the system running the software of the present invention 160 receives new input and another iteration of the above steps is executed.

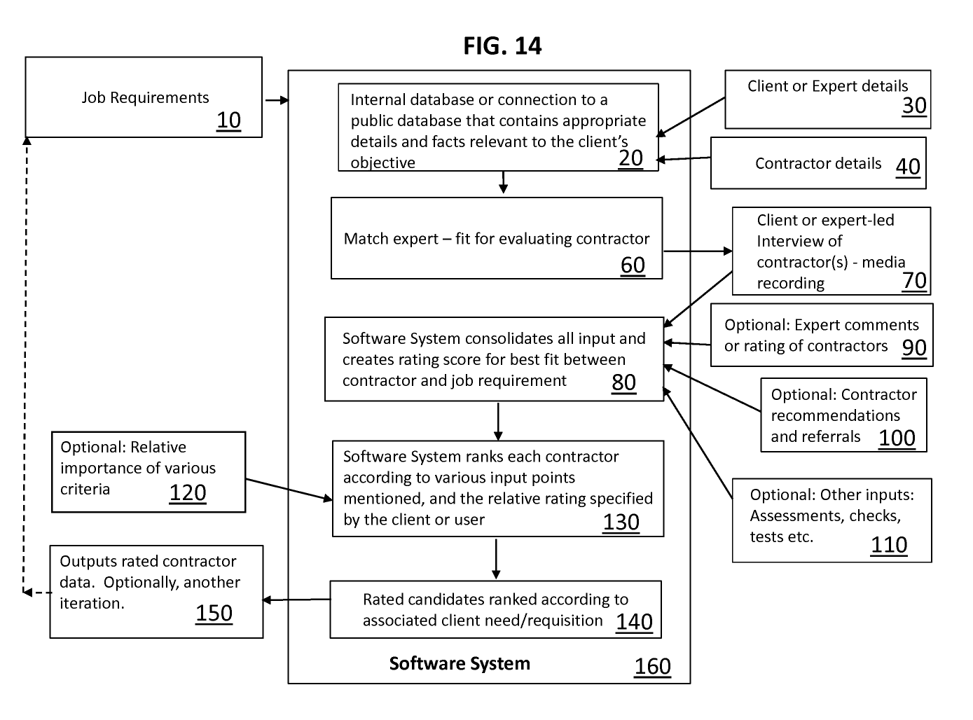

FIG. 14 describes a embodiment of the present invention that assists in evaluating contractors. The client inputs his/her job requirements 10 into the system running the software of the present invention 160. The system running the software of the present invention 160 comprises an internal database 20 or a connection to a public database that contains appropriate details and facts relevant to the client's objective, wherein the details and facts may comprise information about contractors. The database further comprises information about experts who could review these contractors. The client details 30 help match an expert with relevant expertise to the client's objective. The database 20 may further comprise details about the contractors 40 from the user or other public sources. In step 60, the system running the software of the present invention 160 selects an expert suitable for evaluating the contractors based on expert skills, background, and/or availability to the job requirements. The system running the software of the present invention 160 provides the collected information to the user for client expert-led interviews 70 of the contractors 40. The interviews 70 of the contractors 40 may be video or audio recorded for future referencing. The system running the software of the present invention 160 receives input from the client expert-led interviews 70. Said inputs may comprise expert comments or ratings 90 of the contractors 40. The system running the software of the present invention 160 can also receive contractor recommendations and referrals 100 or additional information 110 from assessments, checks, tests, etc. The system running the software of the present invention 160 consolidates all input and creates a rating score 80 to describe the best fit between the contractors 40 and the job requirements 10. In the step 130, the system running the software of the present invention 160 ranks each contractor 40 according to the various inputs described above, comprising the expert led interview 70, expert comments or ratings 90 of the candidates, the candidate recommendations and referrals 100, and the additional inputs 110, and the optional relative weighting 120 specified by the client, expert, or user. In step 140, the system running the software of the present invention 160 determines the top rated contractors 40 and selects a number of options previously requested by the client that best satisfy the associated client job requirements 10. The system running the software of the present invention 160 returns these top-rated, or shortlisted, options 150 to the client. The client would then be able to review the shortlisted contractors 150 and leave the process flow if a satisfactory contractor was identified, or re-enter the process flow if a satisfactory contractor was not identified. If the process flow is reentered, the system running the software of the present invention 160 receives new input and another iteration of the above steps is executed.

1. A system for selecting an expert and receiving expert evaluation data comprising: a computer having access to a database comprising subject matter expert data; where said computer is programmed to perform computer-implemented operations comprising:
receiving solution requirement data;
accessing said database comprising subject matter expert data and comparing said solution requirement data to said subject matter expert data;
selecting at least one subject matter expert;
outputting solution requirement data to said subject matter expert; and
receiving solution option data based on said subject matter expert's evaluation.

2. A system according to claim 1 wherein said computer is programmed to perform an additional computer-implemented operation comprising:
ranking solution options based on said solution option data.

3. A system according to claim 1 wherein said computer is programmed to perform an additional computer-implemented operation comprising:
outputting solution option data.

4. A system according to claim 1 wherein said solution requirement data comprises job requirement data and solution option data comprises candidate evaluation data.

5. A system according to claim 4 where said candidate evaluation data comprises a media recording of said subject matter expert interviewing a candidate.

6. A system according to claim 4 where said candidate evaluation data comprises said subject matter expert's comments on a candidate.

7. A system according to claim 4 where said candidate evaluation data comprises said subject matter expert's candidate ratings.

8. A system according to claim 7 wherein said computer is programmed to perform additional computer-implemented operations comprising:
receiving weightings to apply to said subject matter expert's candidate ratings;
applying said weightings to said subject matter expert's candidate ratings;
calculating candidate rankings; and
outputting candidate rankings.

9. A system according to claim 4 wherein said database further comprises candidate data and wherein said computer is programmed to perform additional computer-implemented operations comprising:
comparing candidate data to job requirement data to generate initial comparison data; and
outputting initial comparison data to said subject matter expert.
